(19) United States
(12) Patent Application Publication
(10) Pub. No.: US 2018/0204099 A1
(43) Pub. Date: Jul. 19, 2018

(54) INFORMATION PROCESSING APPARATUS, THREE-DIMENSIONAL MODELING SYSTEM, AND COMPUTER READABLE MEDIUM STORING INFORMATION PROCESSING PROGRAM

(71) Applicant: FUJI XEROX CO., LTD., Tokyo (JP)

(72) Inventor: Jun Wakamatsu, Yokohama-shi (JP)

(21) Appl. No.: 15/795,335

(22) Filed: Oct. 27, 2017

(30) Foreign Application Priority Data
Jan. 18, 2017 (JP) 2017-007071

(51) Int. Cl. G06K 15/02; B32B 41/00

(52) U.S. Cl. CPC G06K 15/1849; B32B 7/12; B32B 41/00; G06K 15/021

(57) ABSTRACT

An information processing apparatus includes: a generation unit that generates a series of slice image data representing a series of slice images from a plurality of slice data generated by slicing 3D data; a control image data generation unit that generates control image data for formation of a control image representing control data that allow a 3D modeling post-processing apparatus to perform post-processing on recording media on which the series of slice images has been formed by an image forming apparatus; and an output unit that generates, from the slice image data, image formation information that allows the image forming apparatus to form slice images on respective recording media, and outputs the generated image formation information and control image data to the image forming apparatus.

### CROSS-REFERENCE TO RELATED APPLICATIONS

This application is based on and claims priority under 35 USC 119 from Japanese Patent Application No. 2017-007071 filed on Jan. 18, 2017.

### BACKGROUND

### Technical Field

The present invention relates to an information processing apparatus, a three-dimensional modeling system, and a computer readable medium storing an information processing program.

### SUMMARY

According to an aspect of the invention, there is provided an information processing apparatus comprising: a generation unit that generates a series of slice image data representing a series of slice images from a plurality of slice data generated by slicing 3D data; a control image data generation unit that generates control image data for formation of a control image representing control data that allow a 3D modeling post-processing apparatus to perform post-processing on recording media on which the series of slice images has been formed by an image forming apparatus; and an output unit that generates, from the slice image data, image formation information that allows the image forming apparatus to form slice images on respective recording media, and outputs the generated image formation information and control image data to the image forming apparatus.

### BRIEF DESCRIPTION OF THE DRAWINGS

Exemplary embodiments of the present invention will be described in detail based on the following figures, wherein:

FIGS. 1A and 1B are a schematic diagram and a block diagram, respectively, illustrating one example of the configuration of a 3D modeling system according to an exemplary embodiment of the present invention;

FIG. 2 is a schematic diagram showing another example of the configuration of a 3D modeling system according to the exemplary embodiment;

FIG. 3A is a schematic diagram illustrating an image forming process of sheet lamination 3D modeling, and FIG. 3B is a schematic diagram illustrating a post-processing process of the sheet lamination 3D modeling;

FIGS. 4A, 4B and 4C are schematic diagrams showing a slice image formed on a recording medium;

FIGS. 5A and 5B are schematic diagrams illustrating examples of control data that specify a cutting line;

FIGS. 6A and 6B are schematic diagrams illustrating examples of control data that specify a glue application region;

FIG. 7 is a block diagram showing an example of an electrical configuration of an information processing apparatus according to the exemplary embodiment;

FIG. 8 is a block diagram showing an example of a functional configuration of the information processing apparatus according to the exemplary embodiment.

FIG. 9 is a schematic diagram illustrating an example of how a series of slice image data is divided;

FIG. 10 is a schematic diagram illustrating an example of how an image forming process is performed in a divisional manner;

FIGS. 11A and 11B illustrate other examples of how a series of slice image data is divided;

FIG. 12 is a flowchart showing an example of a processing procedure of an information processing program according to the exemplary embodiment; and

FIG. 13 is a sequence diagram illustrating a main operation of the 3D modeling system according to the exemplary embodiment.

### DESCRIPTION OF SYMBOLS

10: Information processing apparatus

12: Image forming apparatus

14: 3D modeling post-processing apparatus (post-processing apparatus)

16: Storing mechanism

18: Communication line

20: Glue applying unit

22: Cutting-out unit

24: Compression bonding unit

26: Conveyance path

40: File format conversion unit

42: Raster processing unit

44: 3D data processing unit

45: Slice processing unit

46: Image data generation unit

47: Control data generation unit

49: Blocking unit

50: Recording medium

60: Image data dividing unit

62: Image data storing unit

64: Image data output unit

66: Control data dividing unit

68: Control data storing unit

69: Control image data generation unit

70: Control image data output unit

P: 3D modeled object

### DETAILED DESCRIPTION

An exemplary embodiment of the present invention will be hereinafter described in detail with reference to the drawings.

### Three-Dimensional Modeling System

### (Overall Configuration)

First, a three-dimensional (3D) modeling system according to the exemplary embodiment of the invention will be described. The 3D modeling system according to the exemplary embodiment manufactures a three-dimensional (3D) modeled object by a sheet lamination 3D modeling method. In the sheet lamination 3D modeling method, plural pieces of slice data are generated by slicing three-dimensional (3D) data of a 3D model by plural planes and a series of slice images is formed on plural sheet-like recording media such as paper sheets on the basis of the plural pieces of slice data. Then 3D modeling post-processing is performed on the plural recording media on which the series of slice images is formed; for example, the plural recording media are laminated by subjecting them to certain processing. How to generate slice data will be described later. The term “series of slice images” means that the slice images correspond to the respective pieces of slice data generated on the basis of the 3D data.

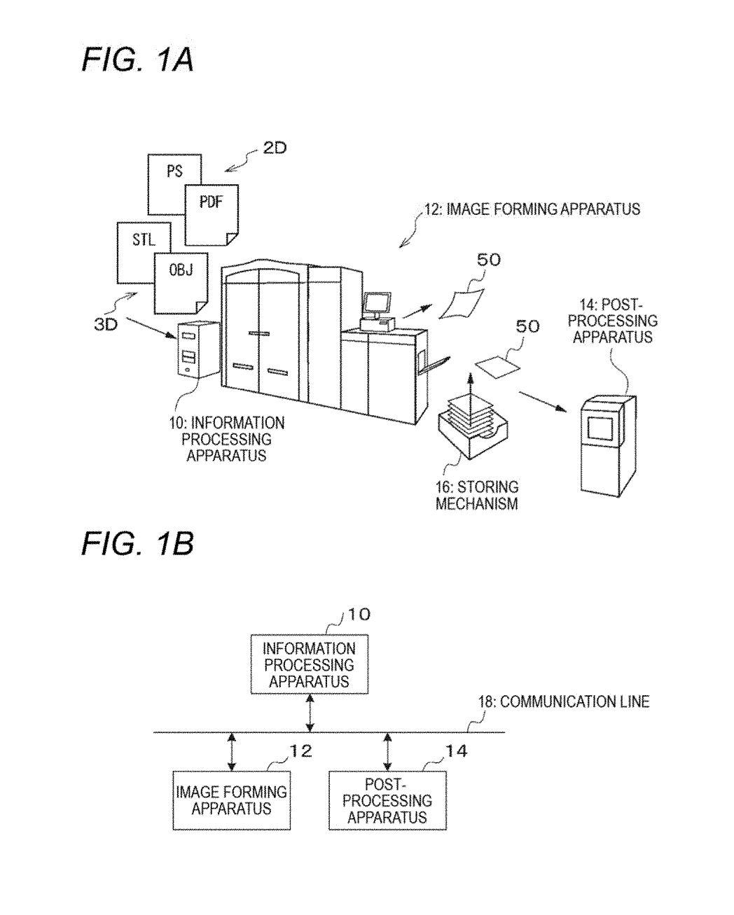

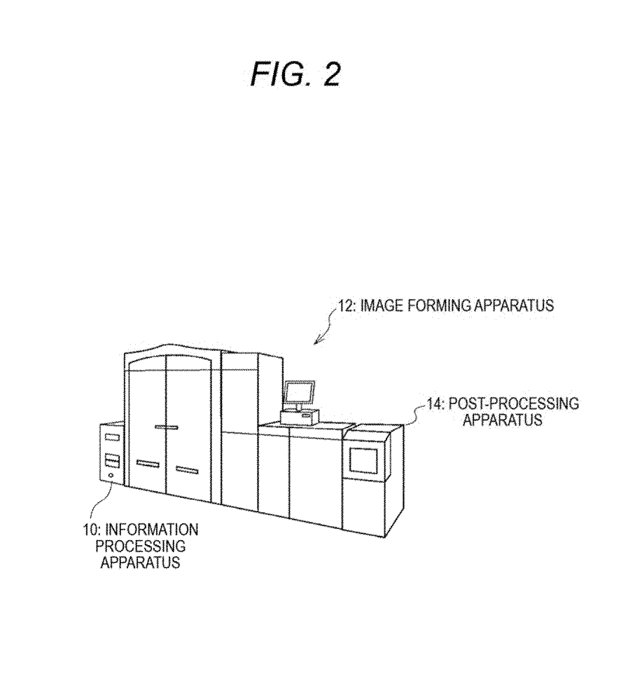

FIGS. 1A and 1B are a schematic diagram and a block diagram, respectively, illustrating one example of the configuration of the 3D modeling system according to the exemplary embodiment. FIG. 2 is a schematic diagram showing another example of the configuration of the 3D modeling system according to the exemplary embodiment.

As shown in FIG. 1A, the one example of the 3D modeling system according to the exemplary embodiment is equipped with an information processing apparatus 10, an image forming apparatus 12, and a 3D modeling post-processing apparatus 14. As shown in FIG. 1B, the information processing apparatus 10, the image forming apparatus 12, and the 3D modeling post-processing apparatus 14 are connected to each other so as to be able to communicate with each other through a communication line 18. In the following description, the 3D modeling post-processing apparatus 14 will be abbreviated as a “post-processing apparatus 14.”

The image forming apparatus 12 forms an image on a recording medium 50 on the basis of raster image data. The raster image data are an example of the “image formation information”. In the exemplary embodiment, the image forming apparatus 12 is not an apparatus dedicated to 3D modeling. The image forming apparatus 12 functions as an ordinary image forming apparatus when it is instructed to perform image formation base on two-dimensional (2D) image data. As such, the information processing apparatus 10 performs different kinds of information processing depending on which of image formation based on 2D image data and 3D modeling based on 3D data it should work for.

The image forming apparatus 12 is an apparatus for forming an image on a recording medium by electrophotography, for example. In this case, the image forming apparatus 12 includes a photoreceptor drum, a charging device, an exposing device, a developing device, a transfer device, a fusing device, etc. The charging device charges the photoreceptor drum. The exposing device exposes the charged surface of the photoreceptor drum to light that reflects an image to be formed. The developing device develops, with toner, an electrostatic latent image formed on the photoreceptor drum by the exposure. The transfer device transfers a toner image formed on the photoreceptor drum by exposure to a recording medium. The fusing device fuses the toner image transferred to the recording medium. The image forming apparatus 12 may be an Inkjet recording apparatus, in which case the image forming apparatus 12 includes an inkjet recording head for ejecting ink droplets toward a recording medium according to an image to be formed and other components.

If instructed to work for 3D modeling based on 3D data, the information processing apparatus 10 generates plural pieces of slice data on the basis of the 3D data. Then, to enable formation of a series of raster images, the information processing apparatus 10 generates a series of raster image data on the basis of the plural pieces of slice data and outputs the generated series of raster image data to the image forming apparatus 12. On the other hand, if instructed to work for image formation based on 2D image data, the information processing apparatus 10 generates raster image data on the basis of the 2D image data and outputs the generated raster image data of a 2D image to the image forming apparatus 12.

If instructed to work for 3D modeling based on 3D data, the information processing apparatus 10 further generates a series of control data on the basis of the plural pieces of slice data. The series of control data is data for allowing the post-processing apparatus 14 to perform 3D modeling post-processing. As described later, control data include control data that specify a cutting line along which to cut out a lamination component from a recording medium and control data that specify a glue application region where glue is applied to the recording medium.

The post-processing apparatus 14 performs 3D modeling post-processing on recording media 50 on which a series of slice images are formed. As shown in FIG. 1A, the post-processing apparatus 14 may be disposed so as not to share a recording medium conveyance path with the image forming apparatus 12 (offline or near-line). Alternatively, as shown in FIG. 2, the post-processing apparatus 14 may be disposed so as to share a recording medium conveyance path with the image forming apparatus 12 (in-line).

Where the post-processing apparatus 14 does not share a conveyance path with the image forming apparatus 12, plural recording media 50 on which a series of slice images is formed are stacked in order of formation of the slice images and stored in a storing mechanism 16 such as a stacker. The bundle of (i.e., stacked) plural recording media 50 is taken out of the storing mechanism 16 and transferred to the post-processing apparatus 14 together. On the other hand, where the post-processing apparatus 14 shares a conveyance path with the image forming apparatus 12, recording media 50 on which respective slice images are formed are fed to the post-processing apparatus 14 one by one. In the exemplary embodiment, explanations are made about the case where the post-processing apparatus 14 does not share a conveyance path with the image forming apparatus 12.

### (Sheet Lamination 3D Modeling)

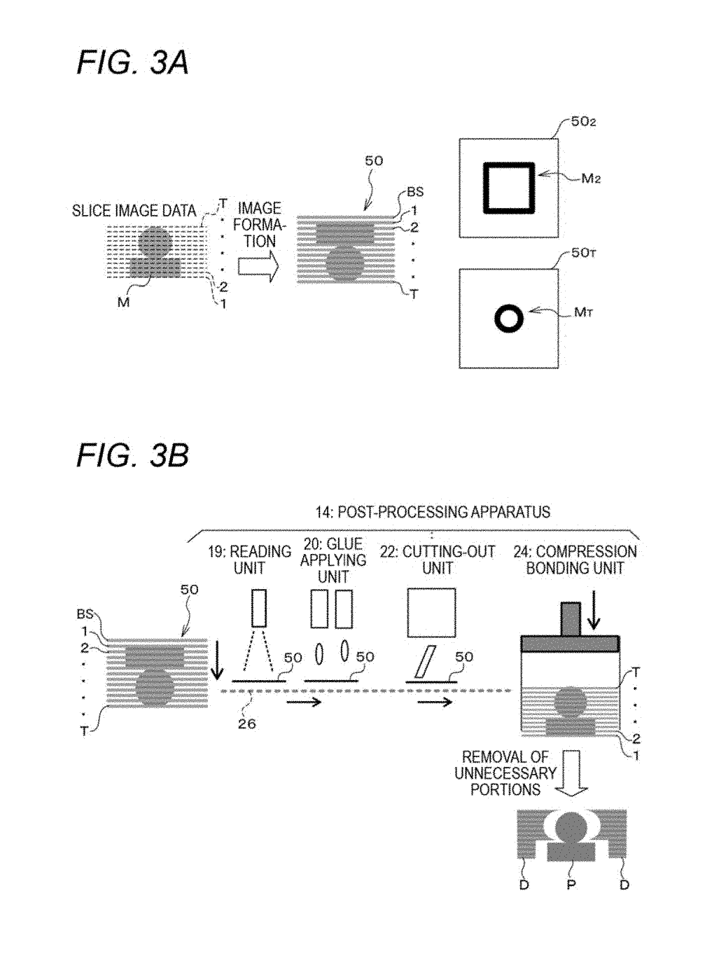

Next, individual processes of sheet lamination 3D modeling will be described. FIG. 3A is a schematic diagram illustrating an image forming process of the sheet lamination 3D modeling, and FIG. 3B is a schematic diagram illustrating a post-processing process of the sheet lamination 3D modeling.

First, raster image data of slice images are generated as shown in FIG. 3A. Although the details will be described later, the information processing apparatus 10 generates plural pieces of slice data on the basis of 3D data of a 3D model M. The slice data represent sectional images obtained by slicing the 3D model M by slicing planes. In the exemplary embodiment, T (first to Tth) pieces of slice data are generated using T (first to Tth) slicing planes. Each of the T pieces of slice data is converted into YMCK raster image data for formation of a corresponding one of T (first to Tth) slice images.

Next, as shown in FIG. 3A, slice images are formed on respective recording media. The image forming apparatus 12 forms a series of slice images on recording media 50 on the basis of the series of raster image data. The plural recording media 50₁ to 50_{T} on which the series of slice images is formed are stacked in order of formation of the slice images. An nth slice image is formed on an nth recording medium 50ₙ, n being a number that is one of “1” to “T”.

In the illustrated example, the T (first to Tth) slice images are formed in order that the number representing each of them descends from “T” to “1.” The plural recording media 50₁ to 50_{T} are stacked in order that the number representing each of them descends from “T” to “1” with the recording medium 50_{T} on which the Tth slice image is formed being the lowest layer. Since the plural recording media 50₁ to 50_{T} are stacked in this order, the post-processing process that follows is supplied with the plural recording media 50₁ to 50_{T} in order that the number representing each of them ascends from “1” to “T.” As such, the image forming apparatus 12 forms T slice images on recording media 50 in the order that is reverse to the order in which the post-processing apparatus 14 performs post-processing.

After the plural recording media 50₁-50_{T} are stacked as shown in FIG. 3A, control images representing control data corresponding to the plural respective recording media 50₁-50_{T} are formed on respective recording media other than the recording media 50₁-50_{T}. The recording media on which the control images have been formed are output as respective banner sheets 50_{BS}. The details of the banner sheets will be described later.

Then, as shown in FIG. 3B, the recording media 50 on which the slice images are formed are subjected to post-processing. In the exemplary embodiment, the post-processing apparatus 14 is equipped with a reading unit 19 which reads control images formed on respective banner sheets 50_{BS}, a glue applying unit 20 which performs a glue applying operation, a cutting-out unit 22 which performs a cutting-out operation, and a compression bonding unit 24 which performs a compression bonding operation. The reading unit 19, the glue applying unit 20, the cutting-out unit 22, and the compression bonding unit 24 are arranged in this order along a conveyance path 26 for feeding recording media 50. The reading unit 19 acquires the series of control data corresponding to the series of slice images by reading and analyzing the control images formed on the respective banner sheets 50_{BS}.

In the exemplary embodiment, images (control images) of, for example, two-dimensional codes such as QR codes (registered trademark) or one-dimensional codes such as barcodes produced through conversion from control data are formed on the respective banner sheets 50_{BS}. The reading unit 19 acquires the control data by reading and analyzing the control images (e.g., two-dimensional codes such as QR codes or one-dimensional codes such as barcodes) formed on the respective banner sheets 50_{BS}.

For example, the banner sheets 50_{BS} are ejected to an ejected sheet receiving unit (not shown) after the control images are read by the reading unit 19. Alternatively, a user may set each banner sheet 50_{BS} at a reading position of the reading unit 19 on a conveyance path 26, have the reading unit 19 read the control image, and remove the banner sheet 50_{BS} from the conveyance path 26 after completion of the reading.

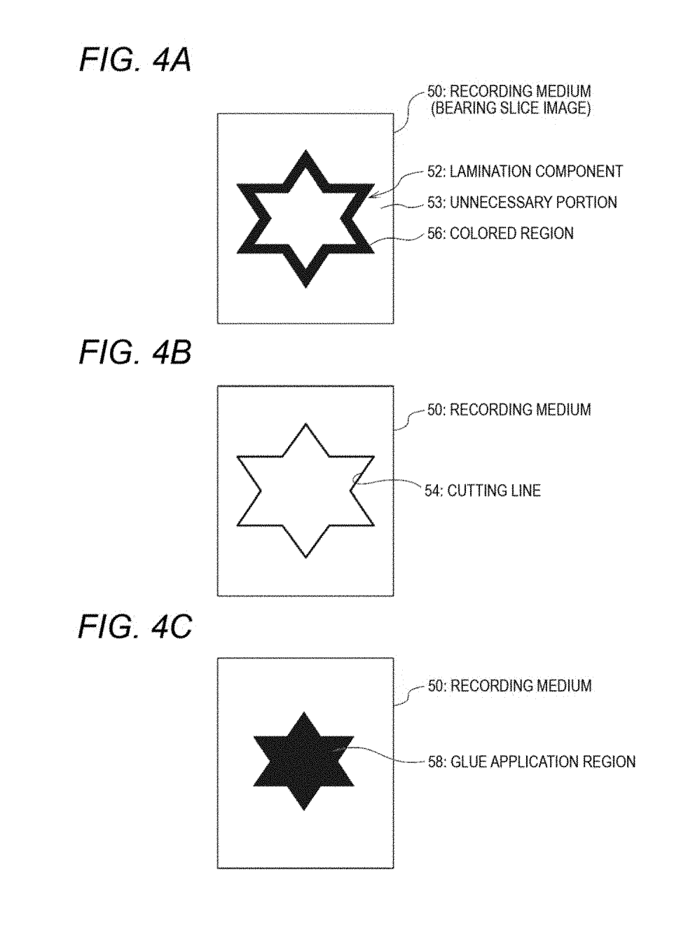

The slice image will now be described. FIGS. 4A-4C are schematic diagrams showing an example slice image formed on a recording medium 50. As shown in FIG. 4A, a slice image formed on a recording medium 50 consists of a lamination component 52 to become part of a 3D modeled object when subjected to lamination and an unnecessary portion 53. The lamination component 52 has a colored region 56 which is a peripheral region having a preset width. As shown in FIG. 4B, the outer circumferential line of the lamination component 52 is a cutting line 54 along which to cut out the lamination component 52 from the recording medium 50.

As shown in FIG. 4C, a glue application region 58 is set inside the outer circumferential line (cutting line 54) of the lamination component 52; for example, the glue application region 58 is the region located inside and adjoining the colored region 56. Although glue may be applied to the entire surface of the recording medium 50 including the unnecessary portion 53, setting the glue application region 58 as a region located inside the outer circumferential line of the lamination component 52 makes it easier to remove removal target portions D (see FIG. 3B) than in the case that glue is applied to the entire surface of the recording medium 50. Furthermore, setting the glue application region 58 as a region located inside the outer circumferential line of the lamination component 52 prevents an event that glue sticks out of the lamination component 52 in a compression bonding operation that is performed after glue application.

A width of the colored region 56 and a retreat width of the glue application region 58 from the outer circumferential line of the lamination component 52 may be set when a user inputs instructions about 3D modeling by, for example, displaying a setting picture on a display 34 of the information processing apparatus 10 and receiving settings from the user through an operation unit 32. Alternatively, preset initial settings may be employed.

Control data include control data that specify the cutting line 54 and control data that specify the glue application region 58. For example, the control data that specify the cutting line 54 are coordinate data of points located on a route of the cutting line 54. The control data that specify the glue application region 58 are coordinate data of points existing in the glue application region 58.

Recording media 50 are supplied to the glue applying unit 20 one by one from a bundle of plural recording media 50. The glue applying unit 20 applies glue to the glue application region 58 of each recording medium 50 according to control data that specify the glue application region 58. For example, the glue applying unit 20 may be equipped with a glue ejection head for ejecting glue, which is moved in a lamination direction (Z direction) and directions parallel with the plane of the recording medium 50 (X and Y directions). Glue is applied to the glue application region 58 of the recording medium 50 as the glue ejection head scans the glue application region 58 while ejecting glue. Upon completion of the glue applying operation, the recording medium 50 is supplied to the cutting-out unit 22.

The cutting-out unit 22 forms a cut in each recording medium 50 along the cutting line 54 according to control data that specify the cutting line 54. For example, the cutting-out unit 22 may be a cutter having a blade. The blade of the cutter is moved in the lamination direction (Z direction) and the directions parallel with the plane of the recording medium 50 (X and Y directions). A cut is formed in the recording medium 50 by moving the blade of the cutter in the X and Y directions while pressing it against the recording medium 50.

A cutting depth is determined by adjusting the position of the blade of the cutter in the lamination direction. The cutting depth may be such that the cut does not reach the back surface of each recording medium 50.

It suffices that the cutter have a function of forming a cut along the cutting line 54 of a recording medium 50, and the cutter is not limited to a mechanical cutter that presses a blade against a recording medium 50. For example, the cutter may be an ultrasonic cutter that forms a cut by applying ultrasonic waves to a recording medium 50 or a laser cutter that forms a cut by irradiating a recording medium 50 with laser light.

Instead of forming a cut in a recording medium 50, the cutting-out unit 22 may form plural perforations in a recording medium 50 along the cutting line 54.

Each recording medium 50 that has been subjected to the cutting operation is supplied to the compression bonding unit 24. The compression bonding unit 24 stacks received recording media 50 successively. The plural recording media 50₁ to 50_{T} are stacked in order that the number representing each of them ascends from “1” to “T.” The compression bonding unit 24 compression-bonds the bundle of stacked plural recording media 50 together by pressing it in the lamination direction. During the pressure bonding, each of the plural glue-applied recording media 50₁ to 50_{T} is bonded to the recording media 50 located immediately above and below in the glue application regions 58.

The recording media 50 that have been subjected to the cutting-out operation are composed of the lamination components 52 that constitute a 3D modeled object P as a result of the lamination and the unnecessary portions 53. In this state, the unnecessary portions 53 are not removed and remain parts of the recording media 50. The unnecessary portions 53 serve as a support member for supporting the 3D modeled object P that is a laminate of the lamination components 52. After completion of the lamination operation of the compression bonding unit 24, removal target portions D are separated from the laminate of the lamination components 52 of the recording media 50, whereby the 3D modeled object P are separated.

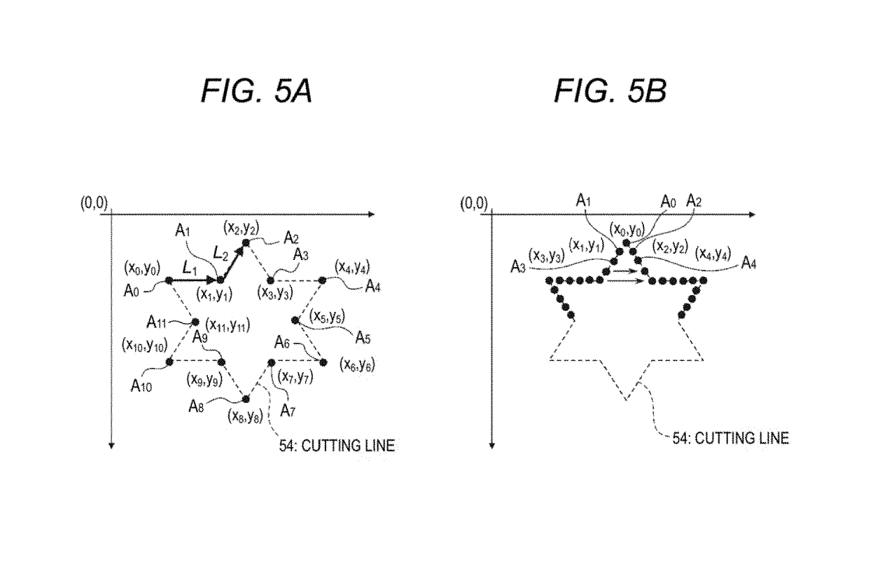

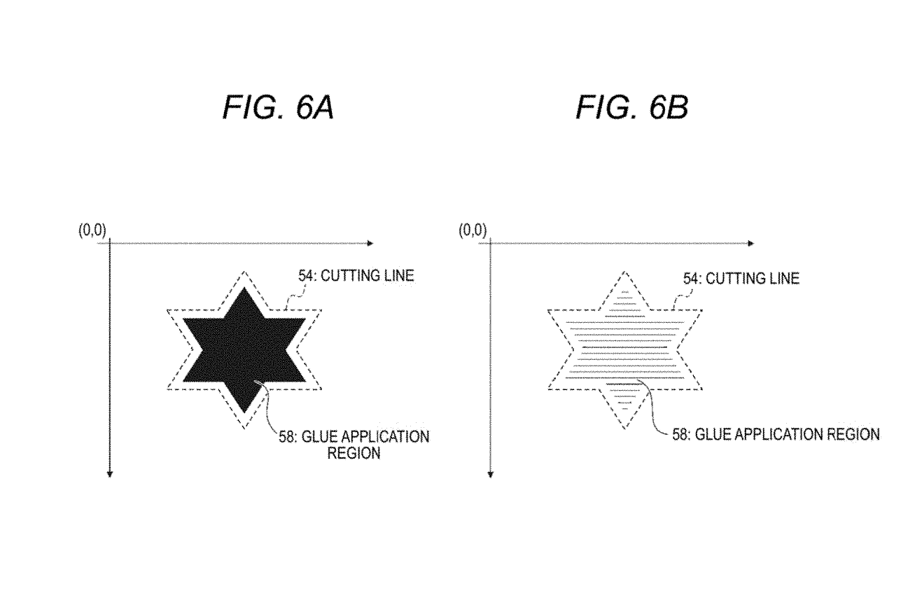

Next, examples of control data will be described. FIGS. 5A and 5B are schematic diagrams illustrating examples of control data that specify a cutting line 54. FIGS. 6A and 6B are schematic diagrams illustrating examples of control data that specify a glue application region 58. As described later, slice data include coordinate data of apices of intersection regions where polygons intersect a slicing plane. The intersection regions exist along the outer circumferential line of a lamination component 52. Thus, as shown in FIG. 5A, coordinate data of respective points located on the route of a cutting line 54, such as coordinates (x₀, y₀) of point A₀, are made control data that specify the cutting line 54.

In the illustrated example, a star-shaped lamination component 52 has twelve apices A₀ to A₁₁. For example, if point A₀ is employed as a start point, the cutting line 54 is specified by tracing the points A₀ to A₁₁ in order of A₀→A₂→A₃→A₄→A₅→A₆→A₇→A₈→A₉→A₁₀→A₁₁.

As shown in FIG. 5B, where plural perforations are to be formed, coordinate data of respective perforations located on the route of a cutting line 54 are made control data that specify the cutting line 54. For example, if point A₀ is employed as a start point, the cutting line 54 is specified by tracing points of the perforations in order of their formation (e.g., A₀→A₂→A₃→A₄ . . . ).

As shown in FIG. 6A, coordinate data of respective points of a glue application region 58 are made control data that specify the glue application region 58. The glue application region 58 is one size smaller than the lamination component 52 and is set inside the outer circumferential line of the lamination component 52. A glue application region 58 may be specified by reducing the image of the lamination component 52. In this case, the glue application region 58 is disposed so that its center of gravity coincides with that of the image of the lamination component 52. Coordinate data of respective points of the glue application region 58 are determined on the basis of its retreat width from the outer circumferential line of the lamination component 52 and coordinate data of points located on the route of the cutting line 54.

As shown in FIG. 6B, it is not necessary to apply glue over the entire glue application region 58. Glue may be applied in selected portions of the glue application region 58. Furthermore, the glue density need not be constant over the entire glue application region 58. Where the glue density is set variable, the glue density may be set higher in a peripheral region of the glue application region 58 than in its central region.

The origin of control data that specify a cutting line 54 and the origin of control data that specify a glue application region 58 are set the same as the origin of slice image formation. Where the post-processing apparatus 14 has an image reading function, a procedure may be employed that the image forming apparatus 12 forms a mark image indicating the origin of control data on a recording medium 50 together with a slice image and the post-processing apparatus 14 acquires position information indicating the origin of control data by reading the mark image.

The form of control data is not limited to coordinate data. For example, control data may be image data in which a cutting line 54, a glue application region 58, etc. are represented by figures or images, such as binary raster image data. In the case of binary raster image data, in the example shown in FIG. 4B, the pixel values of the cutting line 54 are made “1” and those of the other regions are made “0.” In the example shown in FIG. 4C, the pixel values of the glue application region 58 are made “1” and those of the other regions are made “0.” For example, the glue ejection head of the glue applying unit 20 ejects glue toward a recording medium 50 when the pixel value is equal to “1” and does not eject glue toward the recording medium 50 when the pixel value is equal to “0.”

### Information Processing Apparatus 10

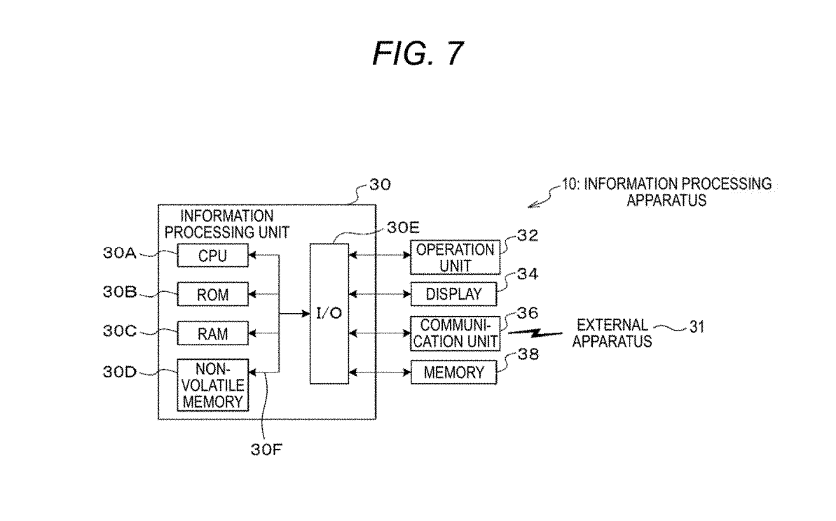

Next, the information processing apparatus 10 according to the exemplary embodiment of the invention will be described. FIG. 7 is a block diagram showing the electrical configuration of the information processing apparatus 10 according to the exemplary embodiment. As shown in FIG. 7, the information processing apparatus 10 is equipped with an information processing unit 30, an operation unit 32 for receiving a user manipulation, a display 34 for displaying information to a user, a communication unit 36 for communicating with an external apparatus 31, and a memory 38 such as an external storage device. The operation unit 32, the display 34, the communication unit 36, and the memory 38 are connected to an input/output interface (I/O) 30E of the information processing unit 30.

The information processing unit 30 is equipped with a CPU (central processing unit) 30A, a ROM (read-only memory) 30B, a RAM (random access memory) 30C, a nonvolatile memory 30D, and the I/O 30E. The CPU 30A, the ROM 30B, the RAM 30C, the nonvolatile memory 30D, and the I/O 30E are connected to each other by a bus 30F. The CPU 30A reads out a program from the ROM 30B and executes the program using the RAM 30C as a working area.

The operation unit 32 receives a user manipulation through a mouse, a keyboard, etc. The display 34 displays various pictures to a user using a display device. The communication unit 36 communicates with the external apparatus 31 through a wired or wireless communicate line. For example, the communication unit 36 functions as an interface for communicating with the external apparatus 31 such as a computer that is connected to a network such as the Internet. The memory 38 is equipped with a storage device such as a hard disk drive.

### (Functional Configuration of Information Processing Apparatus 10)

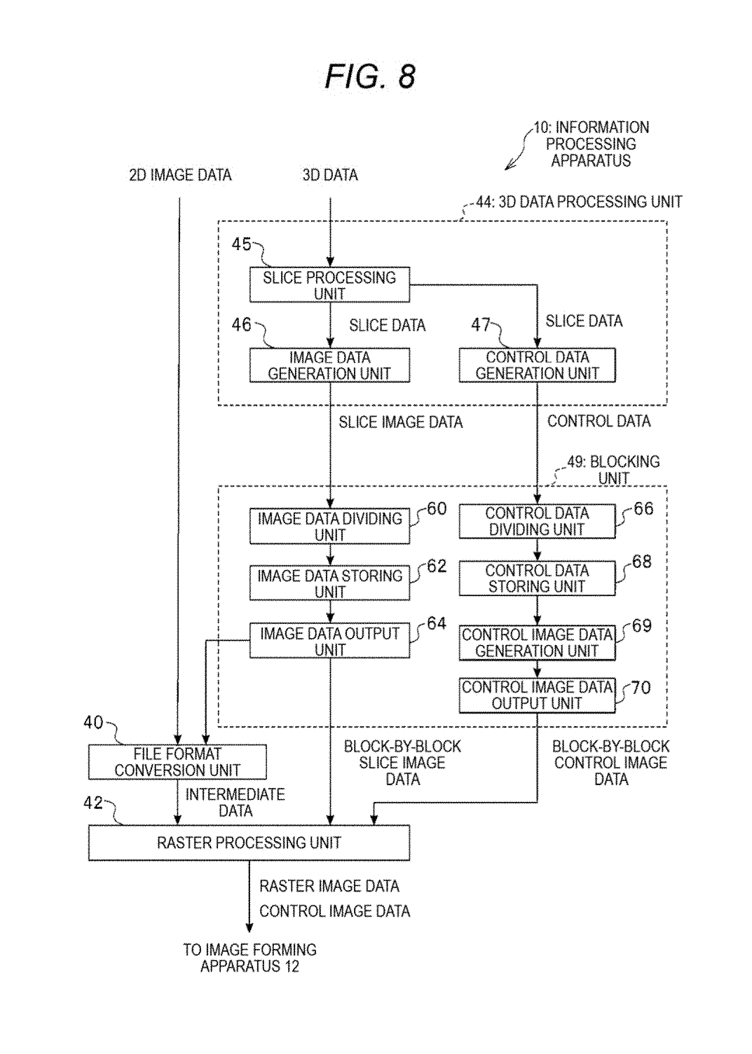

Next, the functional configuration of the information processing apparatus 10 according to the exemplary embodiment will be described. FIG. 8 is a block diagram showing an example functional configuration of the information processing apparatus 10 according to the exemplary embodiment. As shown in FIG. 8, the information processing apparatus 10 is equipped with a file format conversion unit 40, a raster processing unit 42, a 3D data processing unit 44, and a blocking unit 49.

When receiving data written in a page description language (hereinafter referred to as “PDL data”), the file format conversion unit 40 converts the received PDL data into intermediate data.

The raster processing unit 42 generates raster image data by rasterizing the intermediate data produced by the file format conversion unit 40. Furthermore, the raster processing unit 42 generates raster image data and control image data by rasterizing slice image data that are output from an image data output unit 64 (described later) and control image data that are output from a control image data output unit 70 (described later), and outputs the generated raster image data and control image data to the image forming apparatus 12. Still further, the raster processing unit 42 instructs the image forming apparatus 12 to form control images on respective recording media other than recording media 50 on which slice images are formed. The raster processing unit 42 is an example of the “output unit”.

The 3D data processing unit 44 generates slice image data and control data by processing received 3D data. More specifically, the 3D data processing unit 44 is equipped with a slice processing unit 45, the image data generation unit 46, and a control data generation unit 47. The slice processing unit 45 generates slice data on the basis of received 3D data. The image data generation unit 46 generates slice image data on the basis of the slice data received front the slice processing unit 45. The image data generation unit 46 is an example of the generation unit.

The control data generation unit 47 generates control data on the basis of the slice data received from the slice processing unit 45.

The blocking unit 49 is equipped with an image data dividing unit 60, an image data storing unit 62, the image data output unit 64, a control data dividing unit 66, a control data storing unit 68, a control image data generation unit 69, and the control image data output unit 70.

The image data dividing unit 60 divides the series of slice image data produced by the image data generation unit 46 into plural blocks. The image data storing unit 62 assigns pieces of identification information to the plural respective blocks and stores slice image data of each page in such a manner that it is correlated with a piece of identification information of a block to which it belongs. The image data output unit 64 reads out and outputs the series of slice image data block by block.

The control data of plural pages correspond to the slice image data of plural pages, respectively. The control data dividing unit 66 divides the series of control data generated by the control data generation unit 47 into plural blocks in the same manner as the series of slice image data is.

The control data storing unit 68 stores the control data block by block. The control data of each block are stored in such a manner as to be assigned the same identification information as the block to which the corresponding slice image data belong is.

The control image data generation unit 69 reads out control data of one block from the control data storing unit 68, and generates control image data in which the contents of the read-out control data are expressed in the form of an image. In the exemplary embodiment, the control image data generation unit 69 generates control image data in which the contents of the read-out control data are expressed in the form of an image obtained by converting the control data into a two-dimensional code such as a QR code (registered trademark) or a one-dimensional code such as a barcode.

When slice image data of one block are output from the image data output unit 64, the control image data output unit 70 acquires, from the control image data generation unit 69, control image data of control data that belong to the block corresponding to the block to which the slice image data belong.

When slice image data of one block are output from the image data output unit 64 to the raster processing unit 42 and control image data of control data belonging to the corresponding block is output from the control image data output unit 70 to the raster processing unit 42, the raster processing unit 42 generates raster image data by rasterizing the slice image data of one block that are output from the image data output unit 64 and generates raster control image data by rastarizing the control image data of one block that is output from the control image data output unit 70. The raster processing unit 42 outputs the generated raster image data of one block and control image data of one block to an image forming apparatus 12.

In the exemplary embodiment, raster image data of plural blocks and control image data of plural blocks are output to plural image forming apparatus 12 in a distributed manner.

Raster control image data of one block is output following output of raster image data of the corresponding block to an image forming apparatus 12. As a result, a recording medium on which a control image is formed is put, as a banner sheet, on a bundle of recording media 50 on which slice images of one block are formed. The reading unit 19 of the post-processing apparatus 14 reads this banner sheet, whereby the post-processing apparatus 14 acquires the control data.

### (2D Data Processing)

Two-dimensional data processing on 2D image data will be described below. When image formation based on 2D image data is commanded, the 2D image data are data that have been acquired as PDL data. The PDL data are converted by the file format conversion unit 40 into intermediate data, which are output to the raster processing unit 42. The intermediate, data are rasterized by the raster processing unit 42 into raster image data of 2D images, which are output to the image forming apparatus 12.

The intermediate data are interval data produced by dividing each of objects (e.g., font characters, graphic figures, and image data) that are image elements of each page image into intervals of respective raster scanning lines. Each piece of interval data includes sets of coordinates of the two ends of the interval concerned and pieces of information indicating pixel values of respective pixels in the interval. The data transfer rate in the information processing apparatus 10 is increased because the PDL data are converted into the intermediate data and then the latter are transferred.

### (3D Data Processing)

Three-dimensional data processing on 3D data will be described below. When 3D modeling based on 3D data is commanded, 3D data of a 3D model M are acquired. The slice processing unit 45 generates a series of slice data on the basis of the 3D data, and outputs the generated series of slice data to the image data generation unit 46 and the control data generation unit 47. The 3D data and the slice data will be described below in detail.

For example, the 3D data of the 3D model M are OBJ format 3D data (hereinafter referred to as “OBJ data”). In the case of OBJ data, the 3D model M is expressed as a set of polygons (triangles). Alternatively, the 3D data may be of another format such as the STL format. Since STL format 3D data have no color information, color information is added when STL format 3D data are used.

The following description will be directed to the case that the 3D data are OBJ data. The OBJ data include an OBJ file relating to shape data and an MTL file relating to color information. In the OBJ file, surface numbers specific to respective polygons (triangles), coordinate data of the apices of the polygons, etc. are defined so as to be correlated with the respective polygons. In the MTL file, pieces of color information are defined so as to be correlated with the respective polygons.

Planes that are parallel with a ground surface (XY plane) on which the 3D model M is placed are employed as slicing planes. For example, a lowest layer of the 3D model M is set as a first slicing plane. Slice data are generated every time the slicing surface is shifted by a predetermined lamination pitch (distance) p in a lamination direction (Z-axis direction).

The lowest slicing plane is given a number “1” and the slicing plane number is increased by “1” every time the slicing plane is shifted. The example shown in FIG. 3A has T slicing planes having numbers “1” to “T.” Slice data represent sectional images obtained by slicing the 3D model M by the slicing planes, respectively. More specifically, each piece of slice data represents a sectional image of the 3D model M in the form of a slicing plane number, coordinate data of the apices of intersection regions where polygons intersect the slicing plane, and pieces of color information that are set for the respective polygons that intersect the slicing plane. T pieces of slice data (first to Tth slice data) are generated by the T respective slicing planes.

The image data generation unit 46 generates a series of slice image data by converting the slice data of plural pages produced by the slice processing unit 45 into PDL data. The slice image data is PDL data. The slice image data (PDL data) are page-by-page data to be used for forming one slice image for each page. The slice image data may be generated in such a manner that a colored region will be added to each slice image. The generated series of slice image data is output to the image data dividing unit 60.

The image data dividing unit 60 divides the series of slice image data produced by the image data generation unit 46 into plural blocks. The image data storing unit 62 assigns pieces of identification information to the plural respective blocks and stores slice image data of each page in such a manner that it is correlated with a piece of identification information of a block it belongs. The image data output unit 64 reads out and outputs the series of slice image data block by block.

When receiving slice image data of one block, the raster processing unit 42 generates raster image data of one block by rasterizing the received slice image data of one block and outputs the generated raster image data of one block to an image forming apparatus 12.

The identification information is information that indicates that each block is part of a series of slice image data and enables discrimination between plural blocks. For example, the identification information includes block numbers; the plural blocks are assigned consecutive block numbers in the same order as they are subjected to post-processing. A control image representing the contents of control data and a piece of identification information is formed on a banner sheet. Thus, a user is prevented from setting recording media 50 of plural blocks in wrong order in the post-processing apparatus 14, by referring to pieces of identification information formed on respective banner sheets.

Intermediate data may be generated from slice image data. In this case, the image data output unit 64 outputs slice image data (PDL data) of one block to the file format conversion unit 40. The file format conversion unit 40 converts the PDL data of one block into intermediate data of one block and outputs the latter to the raster processing unit 42. The raster processing unit 42 generates raster image data of one block by rasterizing the intermediate data of one block, and outputs the generated raster image data of one block to an image forming apparatus 12.

The control data generation unit 47 generates a series of control data on the basis of slice data produced by the slice processing unit 45, and outputs the generated control data in such a manner that they are correlated with respective slice image numbers (i.e., slicing plane numbers). The control data dividing unit 66 divides the series of control data into plural blocks. The control data storing unit 68 stores the control data in such a manner that the control data of blocks are assigned respective pieces of identification information. The control image data generation unit 69 reads out control data of one block from the control data storing unit 68, and generates control image data. The control image data output unit 70 acquires control image data of control data that belong to the block corresponding to the block to which slice image data of one block belong that are output from the image data output unit 64, and outputs the acquired control image data to the raster processing unit 42.

### (How to Divide a Series of Slice Image Data)

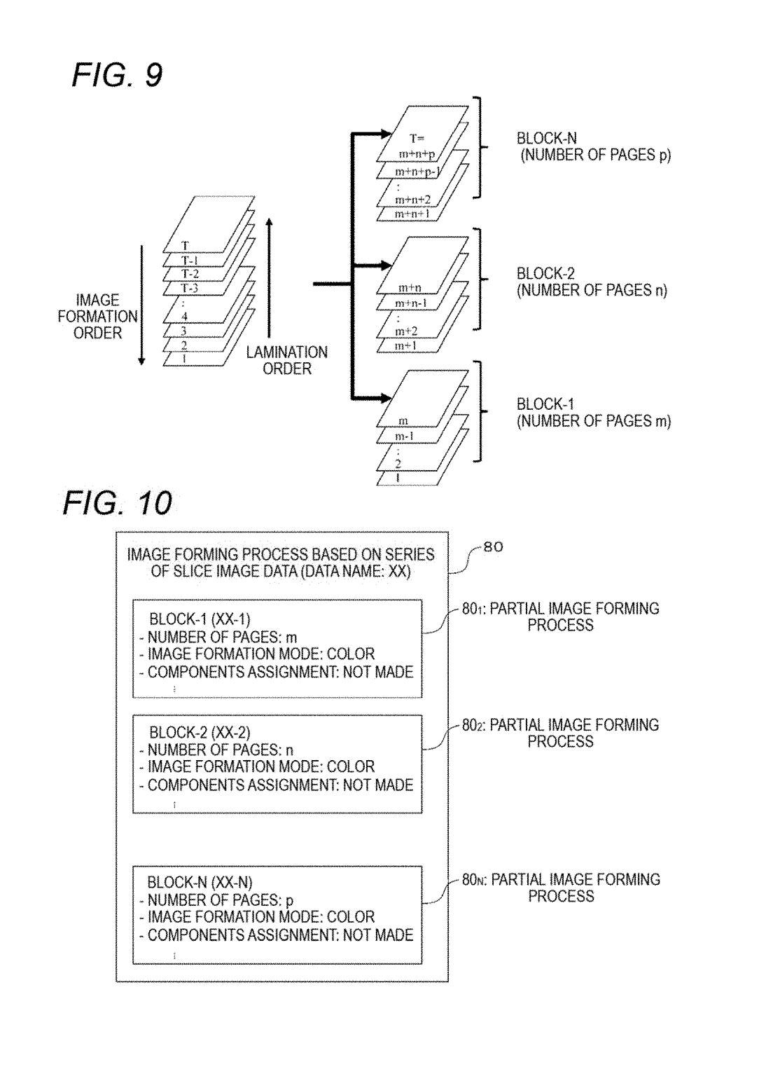

Next, a description will be made of how a series of slice image data is divided. FIG. 9 is a schematic diagram illustrating an example of how a series of slice image data is divided. FIG. 10 is a schematic diagram illustrating an example of how an image forming process is performed in a divisional manner. As shown in FIGS. 9 and 10, slice image data of plural pages are arranged in such a manner a slice image that will be subjected to 3D modeling post-processing later is formed earlier.

In the illustrated example, the series of slice image data is T (first to Tth) slice image data. The T slice image data are formed in descending order of the numbers indicating them starting from “T.” In a post-processing process, plural recording media 50 on which the series of slice image data has been formed are subjected to 3D modeling post-processing and thereby laminated in ascending order of the numbers indicating them starting from “1.”

The T slice image data are grouped into N (first to Nth) blocks, where N is an integer that is larger than or equal to “2.” A kth block is referred to as a block-k. FIG. 9 shows a case that T slice image data are grouped into three blocks (N=3). First to mth slice image data (i.e., m slice image data) belong to block-1, (m+1)th to (m+n)th slice image data (i.e., n slice image data) belong to block-2, and (m+n+1)th to (m+n+p) th slice image data (i.e., p slice image data) belong to block-N (3). Slice images are formed block by block from block-1 to block-N (3), that is, in ascending order of the numbers indicating them.

Slice image data of each of m pages of block-1 has page description information such as “image formation mode: color” and “components assignment: not made.” Likewise, slice image data of each of n pages of block-2 and slice image data of each of p pages of block-N have page description information such as “image formation mode: color” and “components assignment: not made.”

If the T slice image data were not grouped into N blocks as shown in FIG. 10, they would be processed by a single image forming apparatus 12 as a single image forming process 80. In the exemplary embodiment, the T slice image data are grouped into N blocks, whereby an image forming process based on the T slice image data is handled as N image forming processes 80₁-80_{N}. The N image forming processes 80₁-80_{N} are executed in parallel by plural image forming apparatus 12.

The N blocks are managed so as to be correlated with each other by pieces of identification information that are assigned to the respective blocks. For example, file names that are used in storing the slice image data block by block may be used as the respective pieces of identification information of the blocks. In FIG. 10, file names “XX-1,” “XX-2,” and “XX-N” of the respective blocks are ones obtained by adding the numbers indicating the image formation order of the blocks to a file name “XX” of the entire series of slice image data. A partial image forming process is executed by reading out the slice image data of each block from its file.

In the exemplary embodiment, as described above, a banner sheet on which a control image representing identification information and control data of the corresponding block is output at the end of each partial image forming process 80. By virtue of this measure, the boundaries between the plural partial image forming processes 80 are clarified and control data of each block can be acquired by reading and analyzing, by the post-processing apparatus 14, a two-dimensional code such as a QR code (registered trademark) or a one-dimensional code such as a barcode that is formed on a corresponding banner sheet as a control image.

In the example shown in FIG. 9, the T slice image data are grouped into N (three) blocks, that is, block-1 (m slice image data), block-2 (n slice image data), and block-N (p slice image data). The numbers of slice image data belonging to respective blocks may be the same or different from each other. The number of slice image data belonging to each block is equal to that of recording media 50 on which slice images are formed. The number of slice image data belonging to each block may be a predetermined number such as the number of recording media 50 that can be accommodated by a storing mechanism 16.

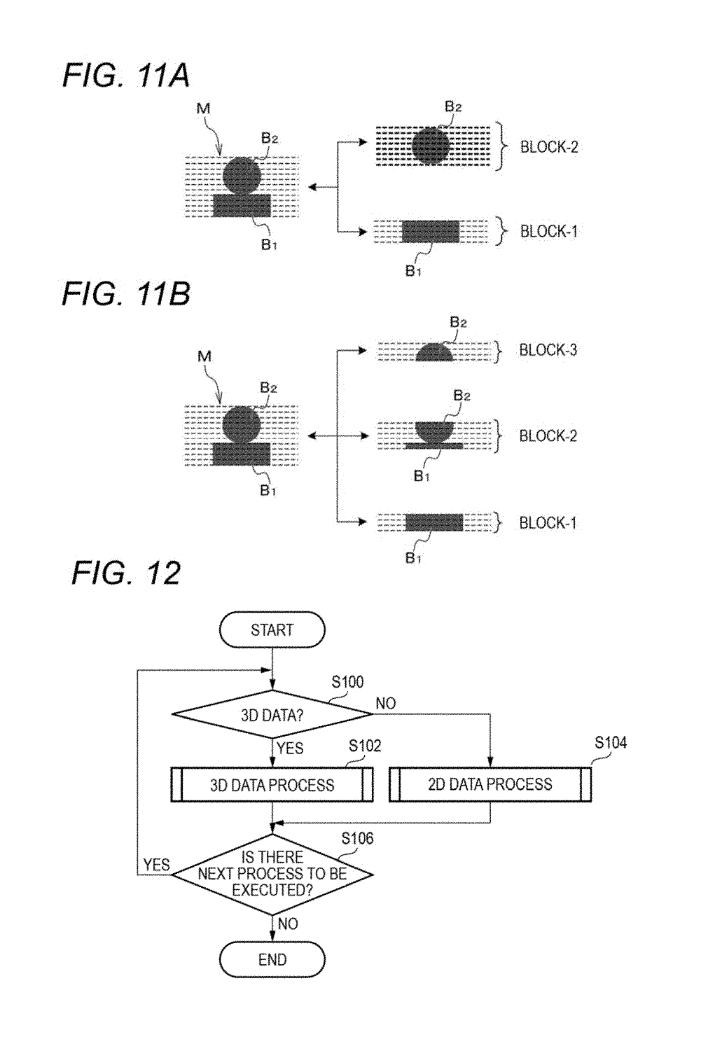

The number of slice image data belonging to each block may be determined according to a shape of a 3D model M. FIGS. 11A and 11B illustrate other examples of how a series of slice image data is divided. A 3D model M is composed of 3D components B₁ and B₂. The 3D model M is reproduced as a 3M modeled object p and the 3D components B₁ and B₂ are reproduced as its components.

In the example shown in FIG. 11A, slice image data corresponding to the 3D component B₁ are block-1 and slice image data corresponding to the 3D component B₂ are block-2. Since the series of slice image data is divided into block-1 and block-2 that correspond to the respective 3D components B₁ and B₂, formation of slice images and post-processing are performed for each 3D component B. Boundaries between blocks may be set at positions where the number of 3D components B varies. This makes it easier to recognize the number of 3D components B.

In the example shown in FIG. 11B, boundaries between blocks are set at pages where the respective slice image areas of the 3D components B₁ and B₂ are large. The series of slice image data is divided into three blocks, that is, block-1, block-2, and block-3. In this example, in the case where formation of slice images and post-processing are performed for each block, the area of bonding between each adjoining set of components of a 3D modeled object is large, which facilitates the bonding.

### Information Processing Program

Next, an information processing program according to the exemplary embodiment will be described. FIG. 12 is a flowchart showing an example processing procedure of the information processing program according to the exemplary embodiment. The information processing program is stored in the ROM 30B of the information processing apparatus 10. The information processing program is read out from the ROM 30B and executed by the CPU 30A of the information processing apparatus 10. Execution of the information processing program is started upon reception of an image formation instruction or a 3D modeling instruction from a user.

Although the exemplary embodiment is directed to the case that the information processing program is stored in the ROM 30B of the information processing apparatus 10 in advance, the invention is not limited to this case. For example, the information processing program may be provided being stored in a computer-readable, portable storage medium such as a magneto-optical disc, a CD-ROM (compact disc-read only memory), or a USB memory or provided over a network.

First, at step S100, the CPU 30A judges whether data relating to an instruction are 3D data. If 3D modeling based on 3D data is commanded, the CPU 30A executes the process shown in step S102. If not, the CPU 30A executes the process shown in step S104, that is, performs the above-described 2D data processing.

At step S106, the CPU 30A judges whether there is a next process to be executed. If receiving an instruction to perform 2D image formation or 3D modeling during execution of the 3D data processing or 2D data processing, the CPU 30A executes the process shown in step S100 (steps S100-S106 are executed again) because there is a next process to be executed. If judging at step S106 that there is no next process to be executed, the CPU 30A finishes the execution of the information processing program.

### Main Operation of 3D Modeling System

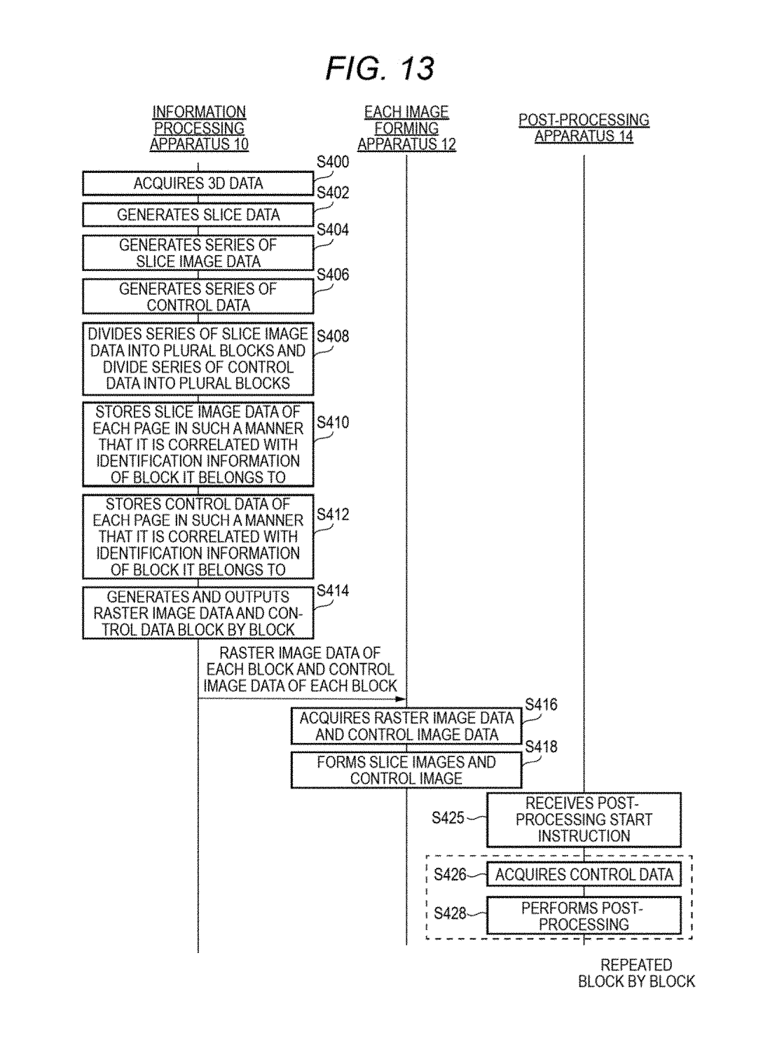

Next, a main operation of the 3D modeling system according to the exemplary embodiment will be described. FIG. 13 is a sequence diagram illustrating a main operation of the 3D modeling system according to the exemplary embodiment.

As shown in FIG. 13, when receiving 3D data at step S400, the information processing apparatus 10 generates a series of slice data on the basis of the received 3D data at step S402.

Then the information processing apparatus 10 generates a series of slice image data from the series of slice data at step S404, and generates a series of control data on the basis of the series of slice data at step S406.

At step S408, the information processing apparatus 10 divides the series of slice image data into plural blocks and divides the series of control data into plural blocks. Since the control data of plural pages correspond to the slice image data of the plural pages, respectively, the series of control data is divided in the same manner as the series of slice image data.

At step S410, the information processing apparatus 10 stores slice image data of each page in such a manner that it is correlated with identification information of the block to which it belongs. At step S412, the information processing apparatus 10 stores control data of each page in such a manner that it is correlated with identification information of the block to which it belongs.

At step S414, the information processing apparatus 10 reads out slice image data of each block and control data of the corresponding block and generates raster image data of each block and control image data of a corresponding block. And the information processing apparatus 10 outputs the generated raster image data of plural pages and control image data of plural pages to the plural image forming apparatus 12 in a distributed manner.

At step S416, each image forming apparatus 12 acquires raster image data of the block assigned to it and control image data of the block assigned to it. At step S418, each image forming apparatus 12 forms slice images on recording media 50 on the basis of the raster image data of the block assigned to it, respectively, and forms a control image on a banner sheet on the basis of the control image data of the block assigned to it. The plural recording media 50 on which the slice images have been formed are stacked in order of formation of the slice images. The banner sheet on which the control image has been formed is put on the plural recording media 50 on which the slice images have been formed. The recording media 50 and the banner sheet are stored in the storing mechanism 16 such as a stacker.

The storing mechanisms 16 are provided so as to correspond to the plural respective image forming apparatus 12, and bundles of recording media 50 of the blocks are stored in the respective storing mechanisms 16. The bundles of recording media 50 of the blocks are stored in the respective storing mechanisms 16 are collected by a user. Since a banner sheet bearing identification information and a control image of each block is placed on the bundle of recording media 50 of the block, the user checks the pieces of identification information written on the banner sheets of the blocks, respectively, sets the bundles of recording media 50 of the blocks in the post-processing apparatus 14 after combining them together in order, and commands a start of post-processing.

At step S426, the post-processing apparatus 14 acquires control data of one block by reading, with the reading unit 19, the two-dimensional code such as a QR code (registered trademark) or the one-dimensional code such as a barcode that is formed on the banner sheet placed on top of the recording media 50 of the block and analyzing the two-dimensional code or one-dimensional code thus read. At step S428, the post-processing apparatus 14 performs post-processing on the plural recording media 50 on which the slice images are formed, according to the acquired control data. Steps S426 and S428 are executed repeatedly block by block.

The post-processing apparatus 14 performs post-processing while picking up the recording media 50 one by one from the top of the bundle of recording media 50 in their stacking direction. That is, the recording media 50 are subjected to a glue application operation and a cutting-out operation one by one and are thus laminated together. The laminated recording media 50 are subjected to compression bonding. After the recording media 50 of all of the blocks are subjected to the post-processing, removal targets D are removed to obtain a 3D modeled object P (see FIG. 3B).

A described above, in the exemplary embodiment, banner sheets bearing control images each of which represents the contents of control data of the corresponding block and includes identification information of the block are put on respective bundles of recording media 50 of plural blocks that are output from the plural image forming apparatus 12 in a distributed manner.

Although in the exemplary embodiment partial image forming processes for plural respective blocks are executed by the plural image forming apparatus 12 in a distributed manner, the invention is not limited to this case. Partial image forming processes for plural respective blocks may be executed by a single image forming apparatus 12. In this case, the partial image forming processes for plural respective blocks may be executed either successively or separately at different times. Furthermore, the partial image forming processes for plural respective blocks may be executed in order that is different from the regular order.

In the exemplary embodiment, control data are acquired by causing the post-processing apparatus 14 to read a two-dimensional code such as a QR code (registered trademark) or a one-dimensional code such as a barcode that is a control image indicating the contents of the control data and analyze the two-dimensional code or one-dimensional code thus read. An alternative configuration is possible in which address information indicating a storage location of control data is converted into an identification code that is, for example, a two-dimensional code such as a QR code (registered trademark) or a one-dimensional code such as a barcode and the identification code is formed on a banner sheet.

In this case, for example, the address information indicates a storage location of control data in the control data storing unit 68. The reading unit 19 of the post-processing apparatus 14 is configured so as to be able to read an identification code that is, for example, a two-dimensional code such as a QR code (registered trademark) or a one-dimensional code such as a barcode. When reading an identification code from a banner sheet, the reading unit 19 sends the resulting address information indicating a storage location of control data to the information processing apparatus 10. In response, the information processing apparatus 10 reads out the control data from the storage location indicated by the received address information, and sends the read-out control data back to the post-processing apparatus 14. The post-processing apparatus 14 performs post-processing according to the received control data. Also in this case, it is preferable that identification information of each block be formed on a banner sheet in the form of, for example, characters that can be recognized by a user.

In the exemplary embodiment, banner sheets are output from the plural image forming apparatus 12 on a block-by-block basis. However, where the order in which the blocks are to be combined together is clear, a single banner sheet bearing control images representing control data of respective blocks may be output from a single image forming apparatus 12. In this case, the number of banner sheets can be reduced.

Although in the exemplary embodiment recording media that are different from recording media 50 on which slice images are formed are used as banner sheets, a control image may be formed on, for example, a margin of each recording medium 50 on which a slice image is formed. In this case, the raster processing unit 42 instructs each image forming apparatus 12 to form a control image on a margin of each recording medium 50 on which a slice image is formed.

A control image may be formed using an invisible material on each recording medium 50 on which a slice image is formed. In this case, the raster processing unit 42 instructs each image forming apparatus 12 to form a control image on each recording medium 50 on which a slice image is formed, using an invisible material. Each image forming apparatus 12 is configured so as to have a function of forming an image using an invisible material such as a magnetic toner or a toner that absorbs infrared light. The reading unit 19 of the post-processing apparatus 14 is configured so as to have a function of reading an image made of an invisible material. Each image forming apparatus 12 forms, using an invisible material, control images on recording media 50 on which respective slice images are formed, and the reading unit 19 of the post-processing apparatus 14 reads the control images made of the invisible material. Since control images are invisible, each image forming apparatus 12 may form (i.e., superimpose) the control images on respective slice images.

In the exemplary embodiment, the processing efficiency is increased by causing the plural image forming apparatus 12 to execute an image forming process in a distributed manner. On the other hand, there is another method for increasing the processing efficiency in which a single image forming apparatus 12 is caused to perform an image forming process by assigning plural slice images to each recording medium 50. In this case, plural components are manufactured by post-processing. Thus, to prevent the plural components from being combined together in wrong order, a control image indicating components assignment information including the number of components assigned to each recording medium 50, order of combining of plural components, and other information is formed on a banner sheet.

The above-described information processing apparatus, 3D modeling system, and program according to the exemplary embodiment are just examples, and it goes without saying that they can be modified without departing from the spirit and scope of the invention.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processing apparatus comprising:
a generation unit that generates a series of slice image data representing a series of slice images from a plurality of slice data generated by slicing 3D data;
a control image data generation unit that generates control image data for formation of a control image representing control data that allow a 3D modeling post-processing apparatus to perform post-processing on recording media on which the series of slice images has been formed by an image forming apparatus; and
an output unit that generates, from the slice image data, image formation information that allows the image forming apparatus to form slice images on respective recording media, and outputs the generated image formation information and control image data to the image forming apparatus.

2. The information processing apparatus according to claim 1, wherein the output unit instructs the image forming apparatus to form the control image on a recording medium that is different from the recording media on which the slice images are formed.

3. The information processing apparatus according to claim 1, wherein the output unit instructs the image forming apparatus to form control images on the recording media on which the respective slice images are formed.

4. The information processing apparatus according to claim 3, wherein the output unit instructs the image forming apparatus to form the control images on the recording media on which the respective slice images are formed, using an invisible material.

5. The information processing apparatus according to claim 1, wherein the control image data generation unit generates the control image data by converting a storage location of the control data into an identification code.

6. The information processing apparatus according to claim 2, wherein the control image data generation unit generates the control image data by converting a storage location of the control data into an identification code.

7. The information processing apparatus according to claim 3, wherein the control image data generation unit generates the control image data by converting a storage location of the control data into an identification code.

8. The information processing apparatus according to claim 4, wherein the control image data generation unit generates the control image data by converting a storage location of the control data into an identification code.

9. The information processing apparatus according to claim 1, further comprising:
an image data dividing unit that divides the series of slice image data into a plurality of blocks; and
a control data dividing unit that divides the control data into a plurality of blocks that correspond to the plurality of respective blocks of the slice image data, wherein:
the control image data generation unit generates control image data for formation of control images representing the control data of the plurality of blocks, respectively; and
the output means outputs the slice image data of the plurality of blocks and the control image data of the plurality of blocks to a plurality of respective image forming apparatus in a distributed manner.

10. The information processing apparatus according to claim 2, further comprising:
an image data dividing unit that divides the series of slice image data into a plurality of blocks; and
a control data dividing unit that divides the control data into a plurality of blocks that correspond to the plurality of respective blocks of the slice image data, wherein:
the control image data generation unit generates control image data for formation of control images representing the control data of the plurality of blocks, respectively; and
the output means outputs the slice image data of the plurality of blocks and the control image data of the plurality of blocks to a plurality of respective image forming apparatus in a distributed manner.

11. The information processing apparatus according to claim 3, further comprising:
an image data dividing unit that divides the series of slice image data into a plurality of blocks; and
a control data dividing unit that divides the control data into a plurality of blocks that correspond to the plurality of respective blocks of the slice image data, wherein:
the control image data generation unit generates control image data for formation of control images representing the control data of the plurality of blocks, respectively; and
the output means outputs the slice image data of the plurality of blocks and the control image data of the plurality of blocks to a plurality of respective image forming apparatus in a distributed manner.

12. The information processing apparatus according to claim 4, further comprising:
an image data dividing unit that divides the series of slice image data into a plurality of blocks; and
a control data dividing unit that divides the control data into a plurality of blocks that correspond to the plurality of respective blocks of the slice image data, wherein:
the control image data generation unit generates control image data for formation of control images representing the control data of the plurality of blocks, respectively; and
the output means outputs the slice image data of the plurality of blocks and the control image data of the plurality of blocks to a plurality of respective image forming apparatus in a distributed manner.

13. The information processing apparatus according to claim 5, further comprising:
an image data dividing unit that divides the series of slice image data into a plurality of blocks; and
a control data dividing unit that divides the control data into a plurality of blocks that correspond to the plurality of respective blocks of the slice image data, wherein:
the control image data generation unit generates control image data for formation of control images representing the control data of the plurality of blocks, respectively; and
the output means outputs the slice image data of the plurality of blocks and the control image data of the plurality of blocks to a plurality of respective image forming apparatus in a distributed manner.

14. The information processing apparatus according to claim 6, further comprising:
an image data dividing unit that divides the series of slice image data into a plurality of blocks; and
a control data dividing unit that divides the control data into a plurality of blocks that correspond to the plurality of respective blocks of the slice image data, wherein:
the control image data generation unit generates control image data for formation of control images representing the control data of the plurality of blocks, respectively; and
the output means outputs the slice image data of the plurality of blocks and the control image data of the plurality of blocks to a plurality of respective image forming apparatus in a distributed manner.

15. The information processing apparatus according to claim 7, further comprising:
an image data dividing unit that divides the series of slice image data into a plurality of blocks; and
a control data dividing unit that divides the control data into a plurality of blocks that correspond to the plurality of respective blocks of the slice image data, wherein:
the control image data generation unit generates control image data for formation of control images representing the control data of the plurality of blocks, respectively; and
the output means outputs the slice image data of the plurality of blocks and the control image data of the plurality of blocks to a plurality of respective image forming apparatus in a distributed manner.

16. The information processing apparatus according to claim 8, further comprising:
an image data dividing unit that divides the series of slice image data into a plurality of blocks; and
a control data dividing unit that divides the control data into a plurality of blocks that correspond to the plurality of respective blocks of the slice image data, wherein:
the control image data generation unit generates control image data for formation of control images representing the control data of the plurality of blocks, respectively; and
the output means outputs the slice image data of the plurality of blocks and the control image data of the plurality of blocks to a plurality of respective image forming apparatus in a distributed manner.

17. The information processing apparatus according to claim 9, wherein control data of each of the plurality of blocks include identification information indicating the block to which the control data belong.

18. The information processing apparatus according to claim 10, wherein control data of each of the plurality of blocks include identification information indicating the block to which the control data belong.

19. A 3D modeling system comprising:
the information processing apparatus according to claim 1;
a single or a plurality of image forming apparatus that form images on respective recording media on the basis of image formation information and control image data generated by the information processing apparatus; and
a 3D modeling post-processing apparatus that performs 3D modeling post-processing on the recording media on which slice images are formed, according to control data corresponding to the respective slice images.

20. A non-transitory computer readable medium storing a program for causing a computer to execute a process for information processing, the process comprising:
generating a series of slice image data representing a series of slice images from a plurality of slice data generated by slicing 3D data;
generating control image data for formation of a control image representing control data that allow a 3D modeling post-processing apparatus to perform post-processing on recording media on which the series of slice images has been formed by an image forming apparatus; and
generating, from the slice image data, image formation information that allows the image forming apparatus to form slice images on respective recording media, and outputting the generated image formation information and control image data to the image forming apparatus.
